(19) United States
(12) Patent Application Publication
(10) Pub. No.: US 2016/0029833 A1
(43) Pub. Date: Feb. 4, 2016

(54) Hot Beverage Brewer

(71) Applicant: Uni-Splendor Corp., Tainan (TW)

(72) Inventor: Yu-Yuan Lin, Tainan (TW)

(21) Appl. No.: 14/447,689

(22) Filed: Jul. 31, 2014

(51) Int. Cl. A47J 31/44

(52) U.S. Cl. CPC A47J 31/446

(57) ABSTRACT

Provided is a hot beverage brewer characterized in that: at least an opening is disposed at the bottom of a chamber of the brewer to correspond in position to holes formed at bottoms of two spaces formed by partitioning a carrying unit disposed in the chamber; filter units for brewing different pre-brew materials are disposed in the spaces, respectively; two upward-extending supporting elements of appropriate height are disposed at predetermined portions of the spaces, respectively, such that the filter units are firmly mounted in the spaces, respectively; the filter units disposed in the carrying unit are swappable such that the filter units and the holes at the bottoms of the spaces correspond in position to an outlet of the brewer as needed; hence, flavors of different hot beverages do not mix during the brewing process.

### BACKGROUND OF THE INVENTION

1. Technical Field

The present invention relates to a hot beverage brewer characterized in that: related components of the brewer correspond in position to an outlet disposed at the bottom of a chamber of the brewer to prevent the flavor of a previously brewed hot beverage (such as tea) from mixing with the flavor of a subsequently brewed hot beverage (such as coffee); and filter units for holding different pre-brew materials are conveniently stored and thus prevented from getting lost.

2. Description of Related Art

There is a wide variety of brewers for making various hot beverages, such as tea and coffee, and the brewers are available in various shapes. Basically, the brewers are designed to allow users to make tasteful hot beverages easily.

The inventor of the present invention aims to improve on the aforesaid conventional hot beverage brewers by filing with the USPTO the patent application entitled Hot Beverage Brewer (application Ser. No.: 13/615,909, and filing date: Sep. 14, 2012) with a view to overcoming a drawback of the prior art, that is, conventional hot beverage brewers are restricted to performing one and only one function. The hot beverage brewer is designed to make various hot beverages, and it comprises a body laterally provided with a water-storing container for holding water, wherein an end of the water-storing container extends to form a pipeline for conveying water heated up to a predetermined temperature to an end of an outbound pipe, wherein predetermined pre-brew materials are disposed at the other end of the brewer and brewed by the brewer, wherein, after the brewed hot beverages have been contained in a chamber of the brewer for a predetermined period of time, an outlet of the chamber is opened so that the brewed hot beverages are introduced into a container disposed below the outlet. The advantages of the hot beverage brewer include: a carrying unit for holding pre-brew materials and related components are disposed at and engaged with the upper rim of the chamber, such that the related components can be changed easily as needed, thereby streamlining the brewing process and widening the application of the hot beverage brewer.

However, the hot beverage brewer still has a drawback. Although the related components for holding the predetermined pre-brew materials can be quickly changed, different brewed hot beverages are introduced into the container below through the same outlet, and thus a newly brewed hot beverage carries a residual trace of flavor of the previously brewed hot beverage. To overcome this drawback, the present invention provides a hot beverage brewer characterized advantageously in that a newly brewed hot beverage (such as tea) does not carry a residual trace of flavor of the previously brewed hot beverage (coffee).

### BRIEF SUMMARY OF THE INVENTION

The present invention aims to overcome a drawback of conventional hot beverage brewers, that is, a newly brewed hot beverage carries a residual trace of flavor of the previously brewed hot beverage. To this end, the present invention provides a hot beverage brewer characterized in that: predetermined components of the brewer correspond in position to an outlet of the brewer as needed, to not only brew different hot beverages but also prevent the flavor of a previously brewed hot beverage from mixing with the flavor of a subsequently brewed hot beverage; and filter units for holding different pre-brew materials are conveniently stored and thus prevented from getting lost.

The first objective of the present invention is to provide a hot beverage brewer for brewing hot beverages. The brewer comprises a body laterally provided with a water-storing container for holding water. An end of the water-storing container extends to form a pipeline for conveying water heated up to a predetermined temperature to an end of an outbound pipe. Predetermined pre-brew materials are disposed at the other end of the brewer and brewed by the brewer. If a user wants to drink brewed hot beverages contained in a chamber at a predetermined time or instantly, the user can open an outlet of the chamber to introduce the brewed hot beverages into a container disposed below the outlet. The brewer is characterized in that: at least an opening is disposed at a predetermined portion of a bottom of the chamber of the brewer; hence, after a carrying unit corresponding in shape to the chamber has been put in the chamber, one of two holes formed at lower ends of at least two spaces formed by partitioning the carrying unit, respectively, corresponds in position to the at least an opening, and filter units for holding different pre-brew materials are disposed in the at least two spaces formed by partitioning the carrying unit; two upward-extending supporting elements of appropriate height are disposed at predetermined portions of the spaces, respectively, such that the filter units are firmly mounted in the spaces, respectively; the filter units adapted for holding different pre-brew materials and disposed in the carrying units are swappable such that the filter units and the holes at the lower ends of the spaces correspond in position to an outlet of the brewer as needed; the upper ends of the filter units for holding the pre-brew materials correspond in position to the outbound pipe for ushering in hot boiled water of a predetermined temperature; and the filter units disposed in the carrying unit are swappable such that the filter units and the holes at the lower ends of the spaces correspond in position to an outlet of the brewer as needed, thereby preventing flavors of different hot beverages from mixing during a brewing process.

The second objective of the present invention is as follows. The two filter units, which are adapted for holding different pre-brew materials and disposed in the at least two spaces formed by partitioning the carrying unit, respectively, are adapted to brew tea leaf and coffee, respectively. The filter unit for brewing tea leaf is provided in the form of a filter cup of a predetermined shape. The filter unit has a circumferential wall and a bottom, both of which are perforated with a plurality of mesh holes. A stopping element is inserted upward into a corresponding one of the holes at the lower ends of the carrying unit corresponding in position to the filter unit, so as to timely hide the hole of the corresponding one of the spaces of the carrying unit. A support portion extends from the lower end of the stopping element and forms circumferentially a plurality of ribs. The support portion is moved upward to define a guiding space together with the bottom of the carrying unit. A limiting segment is disposed at the terminal end of the support portion. The other filter unit for brewing coffee powder is provided in the form of a filter cup of a predetermined shape and has a circumferential wall and a bottom, both of which are perforated with a plurality of mesh holes. The upper opening of the filter unit is covered with a cover perforated with a plurality of mesh holes.

The third objective of the present invention is as follows. A handle portion which can be lifted is disposed at the upper rim of the filter unit for brewing tea leaf. A handle portion which can be lifted is disposed at the upper rim of the filter unit for brewing coffee powder, and the upper opening of the filter unit is covered with a cover, wherein another handle portion which can be lifted is disposed at the upper portions of the periphery of the cover. The handle portions serve as handles.

The fourth objective of the present invention is as follows: two upper edges of two opposing sides of the carrying unit extend upward to form two handle portions, respectively, and the two handle portions allow the filter units to be conveniently removed from the at least two spaces of the carrying unit in a swap.

The fifth objective of the present invention is as follows. An abutting segment is formed at a height-predetermined portion of the chamber for holding the carrying unit, such that the carrying unit can be smoothly admitted into the chamber. Recesses are concavely disposed on two opposing sides of the abutting segment of the chamber, respectively, and adapted to admit the two handle portions extending from the two opposing sides of the carrying unit, respectively.

The sixth objective of the present invention is as follows: the hole formed at the lower end of the space holding the filter unit for brewing coffee powder slants downward, such that hot beverages can easily exit through the outlet disposed at the bottom of the chamber of the brewer.

### BRIEF DESCRIPTION OF THE SEVERAL VIEWS OF THE DRAWINGS

FIG. 1 is an exploded view of a hot beverage brewer of the present invention;

FIG. 2 is a perspective view of the hot beverage brewer and a carrying unit thereof according to the present invention;

FIG. 3 is a partial cross-sectional view of the hot beverage brewer of the present invention, showing components for brewing tea leaf;

FIG. 3A is an enlarged view of part A of FIG. 3;

FIG. 4 is a schematic view of the hot beverage brewer of the present invention, showing how tea is introduced into a container below;

FIG. 4A is an enlarged view of part A of FIG. 4;

FIG. 5 is another perspective view of the hot beverage brewer and the carrying unit thereof according to the present invention; and

FIG. 6 is a partial cross-sectional view of the hot beverage brewer of the present invention, showing components for brewing coffee powder.

### DETAILED DESCRIPTION OF THE EMBODIMENT OF THE INVENTION

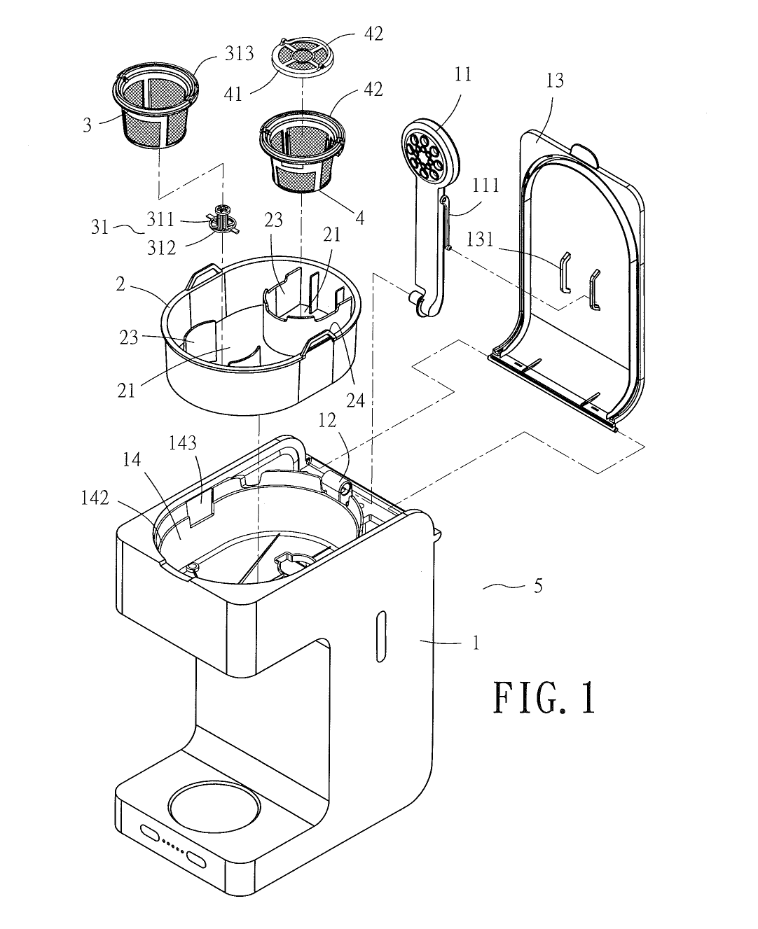

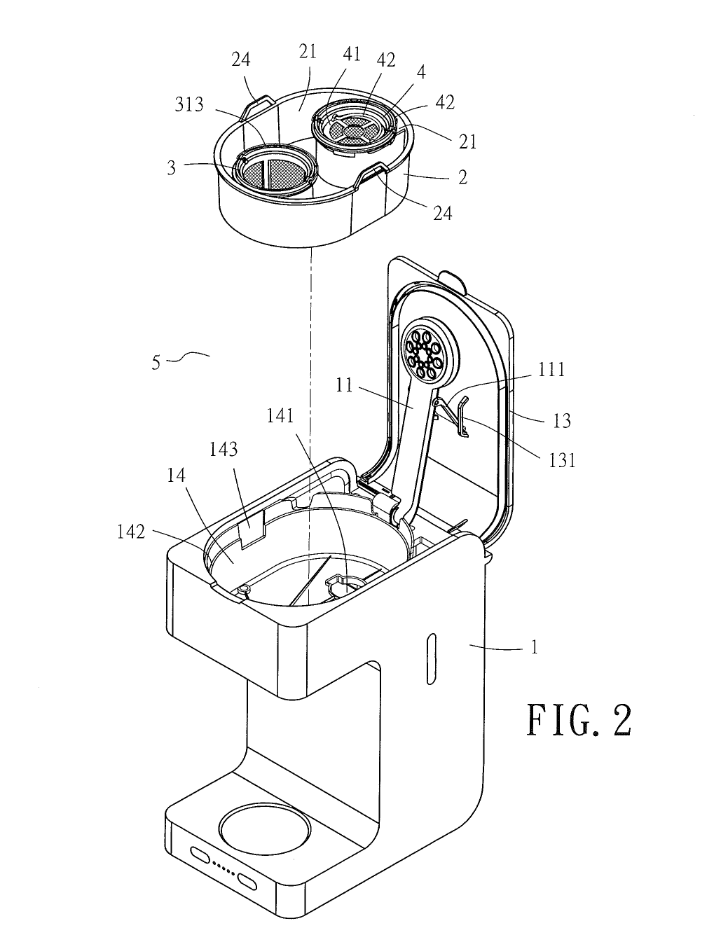

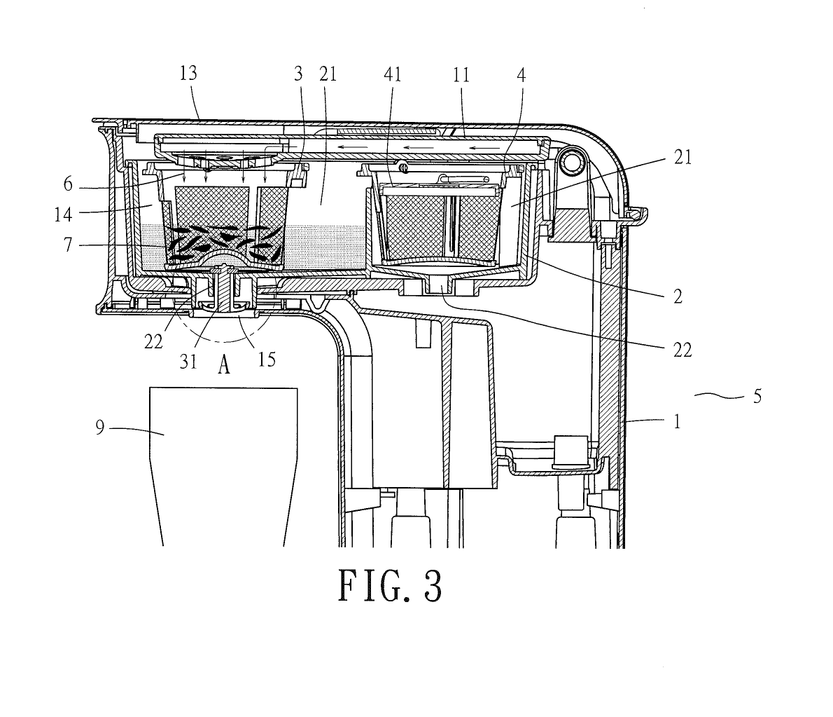

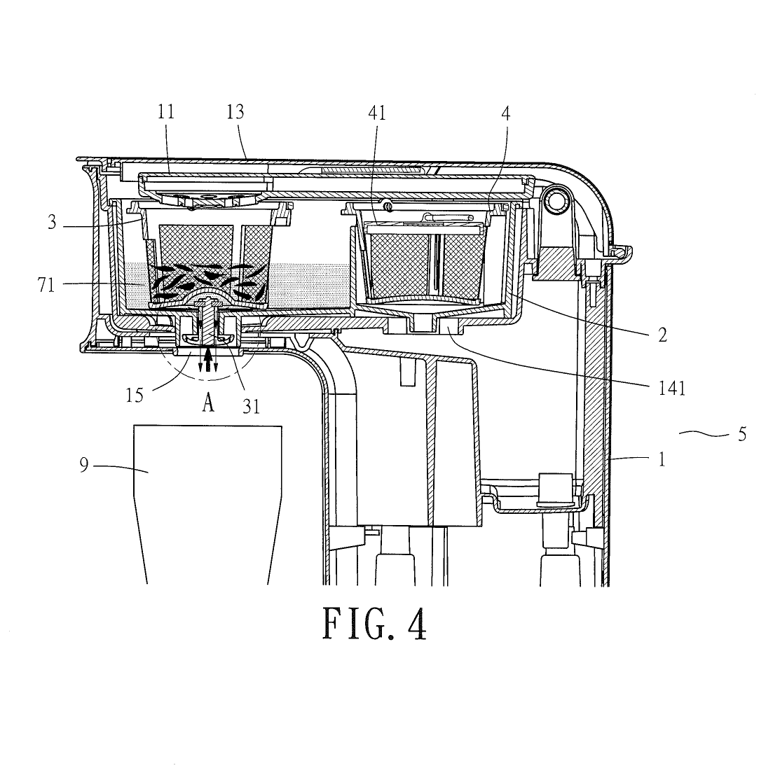

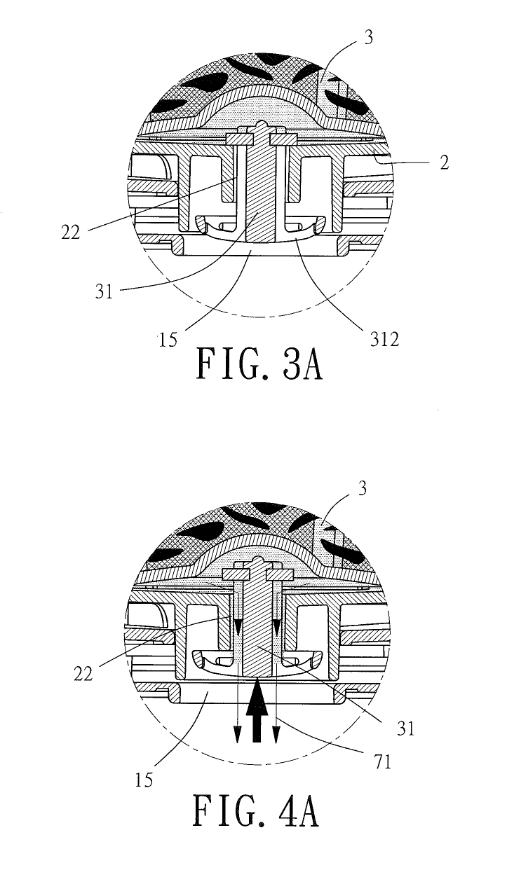

Referring to FIG. 1, FIG. 2, and FIG. 3, the present invention provides a hot beverage brewer 5 for brewing various hot beverages, such as tea leaf, tea bags, and coffee powder. The brewer 5 comprises a body 1. The body 1 is laterally provided with a water-storing container for holding water. One end of the water-storing container extends to form a pipeline for conveying hot boiled water heated up to a predetermined temperature to one end of an outbound pipe 11. One end of the outbound pipe 11 is engaged with a rear pipe segment 12 of the body 1. Two support arms 111 are disposed at the upper portion of the outbound pipe 11 and engaged with limiting members 131 of a lid 13, respectively. Hence, the outbound pipe 11 can be easily mounted and dismounted to facilitate cleaning. Pre-brew materials can be disposed at the other end of the brewer 5 and brewed by the brewer 5. If a user wants to drink brewed hot beverages contained in a chamber 14 at a predetermined time or instantly, the user can open an outlet 15 of the chamber 14 to introduce the brewed hot beverages into a container 9 disposed below the outlet 15. The improvements in the brewer 5 of the present invention are described below.

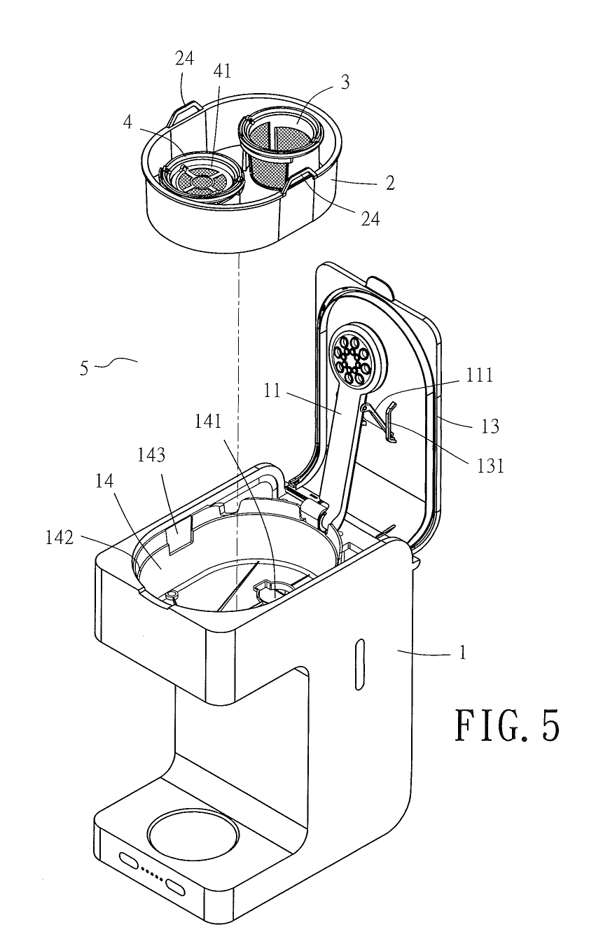

Referring to FIG. 2 and FIG. 3, at least an opening 141 is disposed at a predetermined portion of the bottom of the chamber 14 of the brewer 5, and the outlet 15 in communication with the outside is disposed in front of the at least an opening 141. Hence, after a carrying unit 2 corresponding in shape to the chamber 14 has been put in the chamber 14, one of two holes 22 formed at the lower ends of at least two spaces 21 formed by partitioning the carrying unit 2, respectively, corresponds in position to the at least an opening 141. Filter units 3, 4 for holding different pre-brew materials are disposed in the at least two spaces 21 formed by partitioning the carrying unit 2. The carrying unit 2 comprises two upward-extending supporting elements 23 of appropriate height. The two supporting elements 23 are disposed at predetermined portions of the at least two spaces 21, respectively. Due to the two supporting elements 23, the filter units 3, 4 disposed in the at least two spaces 21, respectively, can be firmly mounted. The carrying unit 2, which holds the filter units 3, 4 for holding different pre-brew materials, is rotatable as needed. Referring to FIG. 2, the filter unit 3 is in front of the filter unit 4. Referring to FIG. 5, the filter unit 4 is in front of the filter unit 3. Therefore, the filter units 3, 4 for holding the pre-brew materials and the holes 22 at the lower ends of the spaces 21 can correspond in position to the outlet 15 of the brewer 5. Furthermore, the upper ends of the filter units 3, 4 for holding the pre-brew materials correspond in position to the outbound pipe 11 for ushering in hot boiled water of a predetermined temperature.

Referring to FIG. 1 and FIG. 3, the filter unit 3 and the filter unit 4, which are adapted for holding different pre-brew materials and disposed in the at least two spaces 21 formed by partitioning the carrying unit 2, respectively, are adapted to brew tea leaf and coffee, respectively. The filter unit 3 for brewing tea leaf is provided in the form of a filter cup of a predetermined shape. The filter unit 3 has a circumferential wall and a bottom, both of which are perforated with a plurality of mesh holes. A stopping element 31 is inserted upward into a corresponding one of the holes 22 at the lower ends of the carrying unit 2 corresponding in position to the filter unit 3, so as to timely hide the hole 22 of the corresponding one of the spaces 21 of the carrying unit 2 as shown in FIG. 3. A support portion 311 extends from the lower end of the stopping element 31 and forms circumferentially a plurality of ribs. The support portion 311 is moved upward to define a guiding space together with the bottom of the carrying unit 2. A limiting segment 312 is disposed at the terminal end of the support portion 311. A handle portion 313 which can be lifted is disposed at the upper rim of the filter unit 3 for brewing tea leaf The filter unit 4 for brewing coffee powder is provided in the form of a filter cup of a predetermined shape. The filter unit 4 has a circumferential wall and a bottom, both of which are perforated with a plurality of mesh holes. The upper opening of the filter unit 4 is covered with a cover 41 perforated with a plurality of mesh holes. A handle portion 42 which can be lifted is disposed at the upper rim of the filter unit 4 for brewing coffee powder. Another handle portion 42 which can be lifted is disposed at the upper portions of the periphery of the cover 41. The two handle portions 42 serve as handles.

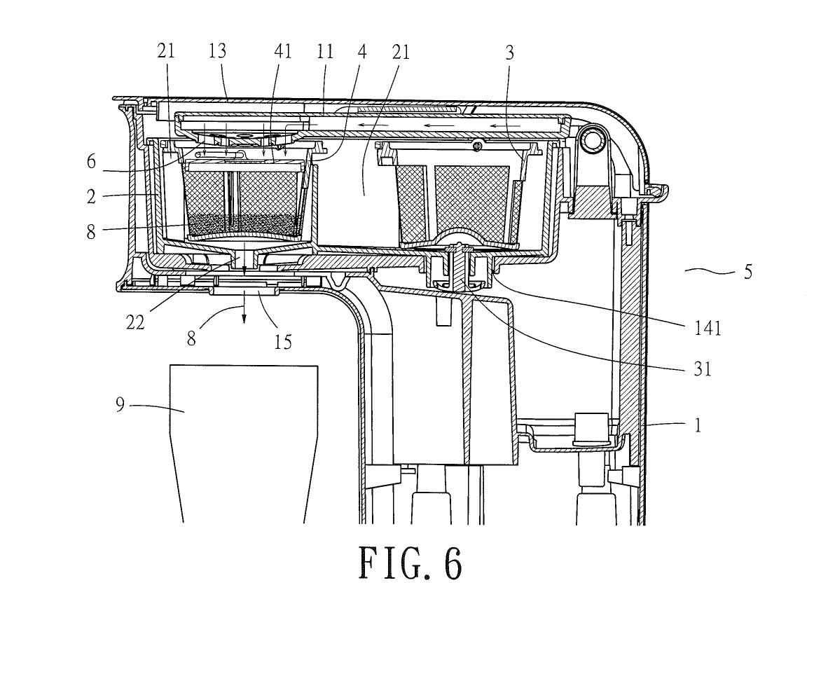

Referring to FIG. 1, two upper edges of the two opposing sides of the carrying unit 2 extend upward to form two handle portions 24, respectively. The two handle portions 24 allow the filter units 3, 4 to be conveniently removed from the at least two spaces 21 of the carrying unit 2 in a swap. An abutting segment 142 is formed at a height-predetermined portion of the chamber 14 for holding the carrying unit 2, such that the carrying unit 2 can be smoothly admitted into the chamber 14 as shown in FIG. 1 and FIG. 3. Recesses 143 are concavely disposed on two opposing sides of the abutting segment 142 of the chamber 14, respectively, and adapted to admit the two handle portions 24 extending from the two opposing sides of the carrying unit 2, respectively. The hole 22 formed at the lower end of the space 21 holding the filter unit 4 for brewing coffee powder slants downward as shown in FIG. 3 and FIG. 6, such that hot beverages can easily exit through the outlet 15 disposed at the bottom of the chamber 14 of the brewer 5.

Referring to FIG. 3 and FIG. 3A, the brewer 5 brews tea leaf by an operating mechanism described below. The carrying unit 2, in which the filter unit 3 is disposed in front of the filter unit 4, is put in the chamber 14 of the brewer 5 in a manner that the hole 22 at the bottom of the carrying unit 2 corresponds in position to the outlet 15 of the chamber 14, whereas the stopping element 31 coupled to the hole 22 of the carrying unit 2 is controlled by an electromagnetic valve (not shown) in moving down to shut and moving up to open. Tea leaf 7 is put in the filter unit 3. Afterward, the chamber 14 of the brewer 5 is covered with the lid 13. Then, hot boiled water 6 of a predetermined temperature is introduced into the space 21 corresponding in position to the filter unit 3, using the outbound pipe 11 coupled to the lid 13 from inside, such that the tea leaf 7 contained in the filter unit 3 is immersed in the hot boiled water 6. After a while, the electromagnetic valve operates and drives the stopping element 31 coupled to the hole 22 of the carrying unit 2 to move upward as shown in FIG. 4 and thus define a guiding space together with the bottom of the carrying unit 2 as shown in FIG. 4A. Hence, tea 71 brewed and contained in the space 21 is introduced into the container 9 below through the guiding space surrounding the stopping element 31 and the outlet 15.

Referring to FIG. 5 and FIG. 6, the brewer 5 brews coffee powder by an operating mechanism described below. The carrying unit 2 is taken out of the chamber 14 of the brewer 5, and then the filter unit 3 is swapped with the filter unit 4, such that the filter unit 4 is disposed in front of the filter unit 3. Then, the carrying unit 2 is put in the chamber 14 of the brewer 5. The hole 22 disposed at the bottom of the carrying unit 2 and slanting downward corresponds in position to the outlet 15 of the chamber 14. A coffee material 8, which is exemplified by ground coffee, is put in the filter unit 4. Afterward, the chamber 14 of the brewer 5 is covered with the lid 13, such that hot boiled water 6 of a predetermined temperature is introduced into the space 21 corresponding in position to the filter unit 4 through the outbound pipe 11 coupled to the lid 13 from inside. Hence, the coffee material 8 contained in the filter unit 4 is brewed, and coffee thus brewed is introduced into the container 9 below through the hole 22 disposed at the bottom of the carrying unit 2 and slanting downward and the outlet 15 of the chamber 14.

The brewer 5 brews tea leaf, tea bags, and coffee powder to make different hot beverages accordingly by the operating mechanism described below. The filter units 3, 4 are put in the spaces 21 formed by partitioning the carrying unit 2. The holes 22 at the bottom of the carrying unit 2 correspond in position to the outlet 15 of the brewer 5. Hence, flavors of different hot beverages do not mix during the brewing process. Furthermore, the filter units 3, 4 for holding different pre-brew materials are conveniently stored and thus prevented from getting lost.

What is claimed is:

1. A hot beverage brewer for brewing hot beverages, comprising a body laterally provided with a water-storing container for holding water, wherein an end of the water-storing container extends to form a pipeline for conveying water heated up to a predetermined temperature to an end of an outbound pipe, wherein predetermined pre-brew materials are disposed at the other end of the brewer and brewed by the brewer, wherein, if a user wants to drink brewed hot beverages contained in a chamber at a predetermined time or instantly, the user can open an outlet of the chamber to introduce the brewed hot beverages into a container disposed below the outlet, the brewer being characterized in that:
at least an opening is disposed at a predetermined portion of a bottom of the chamber of the brewer; hence, after a carrying unit corresponding in shape to the chamber has been put in the chamber, one of two holes formed at lower ends of at least two spaces formed by partitioning the carrying unit, respectively, corresponds in position to the at least an opening, and filter units for holding different pre-brew materials are disposed in the at least two spaces formed by partitioning the carrying unit, wherein two upward-extending supporting elements of appropriate height are disposed at predetermined portions of the spaces, respectively, such that the filter units are firmly mounted in the spaces, respectively; wherein the filter units adapted for holding different pre-brew materials and disposed in the carrying units are swappable such that the filter units and the holes at the lower ends of the spaces correspond in position to an outlet of the brewer as needed, wherein the upper ends of the filter units for holding the pre-brew materials correspond in position to the outbound pipe for ushering in hot boiled water of a predetermined temperature;
the filter units disposed in the carrying unit are swappable such that the filter units and the holes at the lower ends of the spaces correspond in position to an outlet of the brewer as needed, thereby preventing flavors of different hot beverages from mixing during a brewing process.

2. The hot beverage brewer of claim 1, wherein a handle portion which can be lifted and serve as a handle is disposed at an upper rim of each of the filter units for holding the different pre-brew materials.

3. The hot beverage brewer of claim 1, wherein two upper edges of two opposing sides of the carrying unit extend upward to form two handle portions, respectively, and the two handle portions allow the filter units to be conveniently removed from the at least two spaces of the carrying unit in a swap.
